(19) United States
(12) Patent Application Publication
(10) Pub. No.: US 2017/0196763 A1
(43) Pub. Date: Jul. 13, 2017

(54) INTERMITTENT AND SEQUENTIAL COMPRESSION DEVICE AND METHOD

(71) Applicant: Padraic R. Obma, Green Bay, WI (US)

(72) Inventor: Padraic R. Obma, Green Bay, WI (US)

(21) Appl. No.: 15/320,653

(22) PCT Filed: Jun. 22, 2015
(86) PCT No.: PCT/US2015/036920

§ 371 Date: Dec. 20, 2016

Related U.S. Application Data
(60) Provisional application No. 62/119,419, filed on Feb. 23, 2015.
(60) Provisional application No. 62/014,818, filed on Jun. 20, 2014.

(51) Int. Cl. A61H 9/00

(52) U.S. Cl. CPC A61H 9/0078; A61H 2201/0157; A61H 2205/06; A61H 2205/102; A61H 2205/106; A61H 2201/1207; A61H 2201/5033; A61H 2201/5002

(57) ABSTRACT

An intermittent and sequential compression device accommodates an angular placement and application of the device as used within a limb support. The support can incorporate a variety of supports and braces of the type that can be used with human limbs, and the joints of such limbs, in particular. Disposed within the support is a plurality of sequentially-disposed and intermittently inflatable and deflatable air chambers. Each air chamber has an air inlet port and an air outlet port, which can be the same structure or different structure. Each chamber port is to the first end of an air-passage tube. The second end of the air-passage tube is connected a pneumatic pump, the pneumatic pump being connected to an electric power supply and to a controller. The controller operates in accordance with a pre-programmed scheme to alternate the inflation and deflation of the air chambers.

This application claims the benefit and priority of United States Provisional Patent Application No. 62/119,419 filed Feb. 23, 2015, and Provisional Patent Application No. 62/014,818 filed Jun. 20, 2014.

### FIELD OF THE INVENTION

The present invention relates generally to devices and methods for applying intermittent and sequential compressive pressures to a patient's limb or limbs. As used in this application, the word “intermittent” is to be construed as starting or stopping the application of a compressive pressure or force to a patient's limb at an interval that is not necessarily cyclical. Further, the word “sequential” is to be construed to mean the application of a compressive pressure or force to a patient's limb in a way that is cyclical in nature, and further being cyclical in either a temporal sense or in a spatial sense. The present invention also relates generally to devices and methods for supporting patients' arms, shoulders, knees and feet, including such devices as arm slings, knee braces, protective walking boots and other recuperative medical supports and braces. More particularly, the present invention relates to the incorporation of intermittent and sequential compression functionality into such supports and braces (collectively referred to herein as “a support” or “supports”). However, the device and method of the present invention is primarily related to the use of intermittent and sequential compression functionality as applied to supports used with the limb joints of patients. The device and method of the present invention is also primarily related to the use of such a device which is effectively unitary and self-contained as well as fully portable, the device and method allowing the patient-user to ambulate while the device, as part of a support, is in operation. Chambers that are used to apply the compressive pressures or forces may be configured as encircling or non-encircling pneumatic chambers that are disposed within the support so as to allow for application of the chambers fully or partially about the limb of the patient-user. As used in this application, the word “chamber” is to be construed as any discrete compartment or enclosed space comprising a continuous and closed outer wall, the discrete compartment or space being capable of expansion to a full size and shrinkage to a smaller size via pneumatic or hydraulic means through at least one port.

### BACKGROUND OF THE INVENTION

Devices and methods are well known in the medical and surgical arts for intermittently and/or sequentially applying compressive pressures or forces to a patient's limb, typically from a source of pressurized air or fluid and particularly when a patient is confined to a bed or the like. In the experience of this inventor, however, most such devices tend to be “linear” in application. That is, both intermittent pneumatic compression (or “IPC”) devices and sequential compression devices (also known as “SCDs”) that are known in the art are typically configured to apply a fully inflated and then fully deflated state via a single pneumatic cuff or bladder, or are alternatively configured to apply a spatially linear sequence of pressure waves via several bladders. For example, one such device is a “wrap-around” that runs the length of a patient's leg, starting proximally at the patient's upper thigh and ending distally at the patient's lower calf or ankle. Similar linear structures are configured for use with a patient's arms. The waveform in either structure is repeatedly propagated along the length of the patient's leg or arms at regular intervals. These can be intermittent intervals or sequential intervals. It is also possible to initiate a new wave cycle prior to the end of a preceding cycle. This motion is intended, for the most part, to replicate fluid flow patterns in a patient's limb, such as when the patient is ambulatory and the patient's leg muscles are assisting in pumping oxygenated blood to the distal portion of the leg or are pumping oxygen-depleted blood back to the patient's heart. Again, such pressure cycles may be imparted intermittently but not necessarily continuously.

As alluded to above, the structures in the known prior art tend to be a singular linear bladder, thereby requiring that the patient's legs or arms be extended outwardly and generally straight relative to the patient's body. While this is a successful modality, it is not one that is well-adapted for use with human body joints where a joint is required to be immobilized in a bent position for an extended period of time. For example, following shoulder surgery, it is often necessary to immobilize the whole of the patient's arm to allow the tissues surrounding the shoulder to heal. It is also necessary to relieve any stress or pulling on the patient's shoulder and its associated tissues—which stress or pull is normally imparted on the shoulder simply by the weight of the arm—by supporting that weight within a sling, which is a “support,” as defined at the outset of this disclosure. In this scenario, the patient's arm is generally bent such that the upper arm and the lower arm are disposed at a substantially 90° angle relative to one another. In this position, the use of a linear compressive force structure could not be used, at least not while the arm is held in that bent position within the sling.

In the view of this inventor, what is needed is an intermittent and sequential compressive device that can be used within a limb support to the similar effect—as with linear devices—but used when the joint of the patient's limb is required to be fixed within a support and in an angular position, or is required to be reflexed or is flexible, such as in a knee or an ankle. One embodiment of such a device could be with the sling-type arm application discussed above. Another embodiment would be to incorporate an intermittent and sequential compressive device within a knee brace, the knee being supported, but flexibly so. Still another embodiment would be to incorporate an intermittent and sequential compressive device within a boot although, in such a boot, the patient's ankle is typically immobilized. The point being that the compressive device that is configured in accordance with the present invention is formed in a non-linear fashion, the application being angular and/or variably angular to comport with natural limb positions or with natural ranges of motion for such limbs.

When considering an application to human legs or arms in the prior art, intermittent and sequential compression devices tend to function in a linear fashion, as alluded to above. Much like filling a long balloon with air, the intermittent and sequential compressive device of the known art tends to expand in a linear fashion. That is, SCD or IPC devices known in the art are typically configured to apply a fully inflated and then fully deflated state via a single pneumatic cuff or bladder. One such example is described and illustrated in U.S. Pat. No. 3,865,103 to Folman (“Folman”). Folman also teaches the use of “pulsed” air supplies into a singular sleeve. Other devices are alternatively configured to apply a spatially linear sequence of pressure waves via several bladders. One such example is described and illustrated in U.S. Pat. No. 8,394,042 to Mirza. In short, the devices of the prior art tend to “straighten out” linearly simply because of the way they are constructed or typically configured. The ability to perform the same type of compressive wave-like functionality in a way that negotiates around a corner or bend in the human anatomy, such as at a normally bendable joint, is at the heart of the problem which is addressed by the devices and methodology of the present invention.

### SUMMARY OF THE INVENTION

In view of the foregoing, an intermittent and sequential compression device has been devised that accommodates an angular placement and application of the device as used within a limb support. Again, it is to be understood that the word “support” incorporates all types of supports and braces of the type that can be used with human limbs, and the joints of such limbs, in particular.

In the device and method of the present invention, one specific embodiment of the intermittent and sequential compression device is incorporated into an arm sling. In that embodiment, the arm sling still comprises a sling portion and a strap portion, as in a conventional arm sling. Disposed within the sling, however, is a plurality of sequentially-disposed and intermittently inflatable and deflatable discrete air chambers. Each air chamber has an air inlet port and an air outlet port, wherein the air inlet port and the air outlet port may be configured into the same structure or can be configured in different structures, depending on the placement of the ports relative to the air chamber position. That is, air can be used to inflate the chamber via the air inlet port and air can be deflated from the air chamber via a separate air outlet port. Alternatively, air can inflate the chamber via a port which serves as both as an air inlet and an air outlet. Each chamber of the sling is then connected via the port, or ports, to the first end of an air-passage tube. The second end of the air-passage tube is connected to a pneumatic pump, the pneumatic pump being connected to an electric power supply and to a controller. The power supply can be self-contained or be provided by plugging the pump into an AC power supply via an AC to DC converter. The controller operates in accordance with a pre-programmed scheme to alternate the intermittent inflation and deflation of the sequentially-disposed air chambers. During use, the pneumatic pump is connected to the ports described above via the tubes such that the sequencing of inflation and deflation of the chambers via air filling and emptying of the chambers can be accomplished.

In one embodiment of the device of the present invention, a pad portion may be disposed between the patient-side of the arm sling and the patient. The pad portion can be used to house the pneumatic pump, the power supply and the controller. In this embodiment, the power supply would be self-contained, such as by a DC battery pack. Alternatively, the power supply could also be configured to plug into an AC power supply—although portability of the device is the preferred embodiment of the present invention.

In accordance with the present invention, chambers are disposed within the intermittent and sequential compression device at or near a joint, such as at an elbow or a knee. Further, the chambers can be configured and positioned in a certain way to allow inflation of the chambers without the overall structure of the support being pushed outwardly and assuming a longitudinally-extending position. In short, chambers can be configured to be contoured such that inflation will accomplish the inflation/deflation functionality while also maintaining the overall angularity of the support.

In alternative embodiments, the chambers within the device can be individual elements positioned in such a way that the chambers do not have a common margin. This is true of discrete chambers that are disposed within the device and of chambers that envelop the patient joint. In other embodiments, the chambers are disposed adjacent one another such that adjacent chambers share a common margin. All such chamber positioning is within the scope of the present invention.

In alternative embodiments, other configurations for intermittent and sequential compression devices and for intermittent and sequential compression methodologies are disclosed, all of which are included within the scope of the present invention. The foregoing and other features of the present invention will be apparent from the detailed description that follows.

### BRIEF DESCRIPTION OF THE DRAWINGS

FIG. 1 is a front elevational view of one embodiment of the intermittent and sequential compression device that is constructed in accordance with the present invention and showing the device as an arm sling worn by a patient, the patient being shown in phantom view.

FIG. 2 is a cross-sectioned front elevational view of the device illustrated in FIG. 1 and showing the compression chambers as discrete elements that are disposed to one side of the sling.

FIG. 3 is a right side elevational view of the device illustrated in FIG. 1 and showing a pad disposed to the patient-side portion of the sling.

FIGS. 4-6 illustrate the wavelike action of a series of compression chambers that are representative of the device of the present invention.

FIG. 7 is a cross-sectioned front elevational view of an alternative embodiment of the device illustrated in FIG. 1 and showing the compression chambers, which fully encircle a portion of the patient's arm and elbow, disposed to one side of the sling and adjacent chambers not having a common margin.

FIG. 8 is a view similar to that shown in FIGS. 1 and 7 but showing the compression chambers, which also fully encircle a portion of the patient's arm and elbow, disposed to one side of the sling but where adjacent chambers have a common margin.

FIG. 9 is a perspective view of one of the compression chambers shown in FIG. 8, the chamber being shown in a fully inflated condition and further being one of the chambers disposed at or near the patient's elbow.

FIG. 10 is a cross-sectioned view of the chamber illustrated in FIG. 9 and showing the difference in diameters at opposing ends of the chamber.

FIG. 11 is a partially cross-sectioned right elevational view of the devices taken along line 11-11 in both FIGS. 7 and 8.

FIG. 12 is a partial top and cross-sectioned view of the device shown in FIG. 7 and taken along line 12-12 of FIG. 11, the chambers being shown in a deflated condition.

FIG. 13 is an enlarged view of one of the chambers shown in FIG. 12, taken along line 13-13 of FIG. 12, and illustrating the chamber in an inflated condition.

FIG. 14 is a left side elevational view of another alternative embodiment of the intermittent and sequential compression device that is constructed in accordance with the present invention and showing the device incorporated into a support, which is a knee brace worn by a patient, the chambers being shown in phantom view.

FIG. 15 is a left side elevational view of an alternative embodiment of the intermittent and sequential compression device that is constructed in accordance with the present invention and showing the device as an ankle brace worn by a patient, the chambers again being shown in phantom view.

FIG. 16 is a top, front and left side perspective view of an alternative embodiment of the intermittent and sequential compression device that is constructed in accordance with the present invention and showing the device within a support, which is a walking boot that would be worn by a patient.

FIG. 17 is the same view of the walking boot shown in FIG. 16 but showing the walking boot in an exploded view.

FIG. 18 is a cross-sectioned left side elevational view of the walking boot shown in FIG. 16, taken along line 18-18 in FIG. 16.

FIG. 19 is a view similar to that shown in FIG. 18, but showing the placement of air inlet tubes together with a stop flow element disposed between the chambers illustrated.

FIG. 20 is a view similar to that shown in FIG. 18, but showing the compression device as having multiple chambers disposed within the walking boot.

FIG. 21 is a first schematic view of the valving used in the present invention and illustrating how adjacent chambers, each having an air inlet port and an air outlet port, are inflated and deflated in accordance with a preprogrammed scheme.

FIG. 22 is a second schematic view similar to FIG. 21 but showing the air inlet ports and the air outlet ports being separately actuated by the controller in accordance with a preprogrammed scheme.

FIG. 23 is a third schematic view similar to FIG. 22 but showing the air inlet ports and the air outlet ports configured within a common valve element.

### DETAILED DESCRIPTION

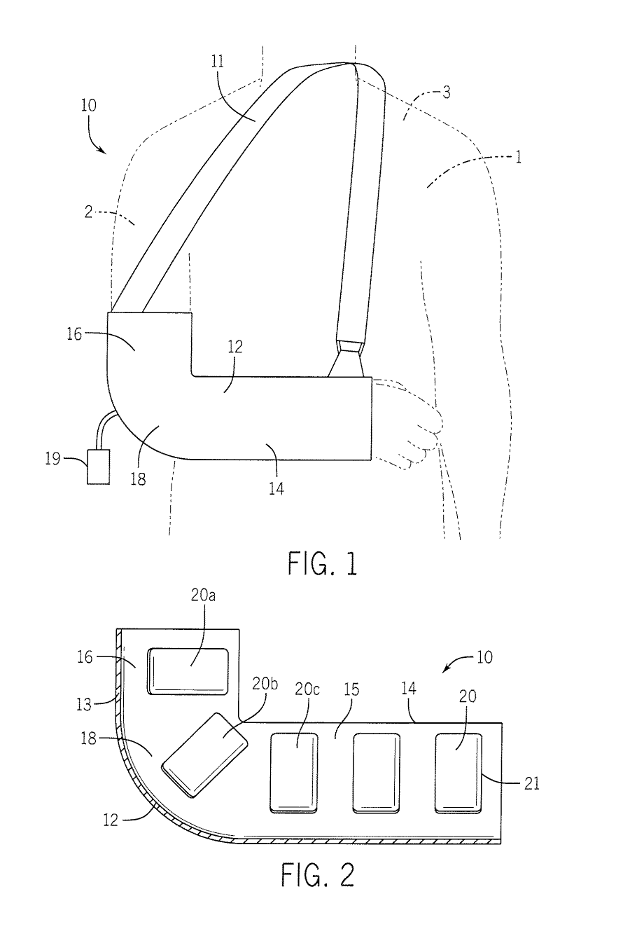

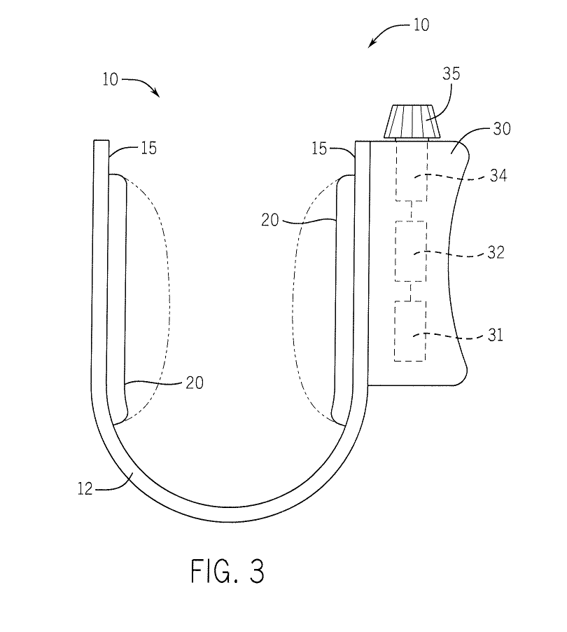

Referring now to the drawings in detail wherein like numbers represent like elements throughout, FIG. 1 illustrates a front elevational view of an arm sling, generally identified 10, that is constructed in accordance with the present invention. The sling 10 is intended to be used to support the arm 2 of a patient 1, the patient being shown in phantom view. The sling 10 comprises a conventional strap 11 and a supporting member 12, the strap 11 being hung over the patient's shoulder 3. The supporting member 12 comprises a trough-like structure having a horizontally-extending portion 14 and a vertically-extending portion 16. Disposed between the horizontally-extending portion 14 and the vertically-extending portion 16 is a bend or elbow portion 18. When used as intended, the horizontally-extending portion 14 supports the patient's forearm (not shown), the vertically-extending portion 16 supports the lower portion of the patient's upper arm 2, and the bend or elbow portion 18 supports the patient's elbow (also not shown). Lastly, a power supply, controller and/or a pneumatic pump subassembly 19 is illustrated in schematic representation, the functionality of which is variable and the placement of which is also variable in accordance with the present invention. Alternatively, the same subassembly 19 could be contained within a pad 30 that is included with the sling 10, the pad being disposed to the patient-side of the sling 10. See FIG. 3, for example.

Referring now to FIG. 2, a cross-sectioned view of the supporting member 12 of the sling 10 is illustrated. As shown, the supporting member 12 comprises an outer structure 13, the outer structure 13 further comprising an inner surface 15. A plurality of discrete inflatable chambers 20 are disposed along that inner surface 15. For the purpose of simplicity, only five chambers 20 are shown. It is to be understood that the present invention is not limited to that number of chambers 20. A larger or smaller number of chambers 20 could be used within the sling 10. Further, the precise positioning of the chambers 20 is not limited to the positions shown in FIG. 2. Significant, however, is the fact that at least one chamber 20a is disposed within the vertically-extending portion 16, at least one chamber 20b is disposed at the elbow (or joint) portion 18 and at least one chamber 20c is disposed along the horizontally-extending portion 14 of the supporting member 12 portion of the sling 10. Further, it is to be assumed that opposing chambers are disposed on the opposite side of each chamber 20a, 20b, 20c. Also see FIG. 3.

It is also to be noted that each air chamber 20 generally comprises a peripheral margin 21 which allows the chamber 20 to be sealed without air leakage. As shown in FIG. 2, each chamber 20 is substantially rectangular in shape when viewed from the front or back. However, the shape of the chambers 20 can be varied and the rectangular shape is not a limitation of the present invention. The only way that air can enter into or exit from the chamber 20 is via at least one port that is connected, in turn, to a flexible pneumatic tube, which will be made apparent later in this detailed description. That is, each air chamber 20 can comprise an air inlet port and an air outlet port, although the air inlet port and the air outlet port may be the same structure or different structures. In this way, air can be used to inflate the chamber 20 via the air inlet port and air can be released from the air chamber 20 via a separate air outlet port. Alternatively, air can inflate the chamber 20 via a single port which can serve as both as an air inlet and an air outlet. Each chamber 20 of the sling is then connected via the port, or ports, to the first end of an air-passage tube. The second end of the tube would then be connected to a pneumatic pump. The size and placement of the ports and tubes is a design expediency and not a limitation of the present invention.

As alluded to previously, FIG. 3 is a right side elevational view of the device illustrated in FIG. 1. It shows a pad 30 that is disposed to the patient-side portion of the sling 10. As shown, the chambers 20 within the inner surface 15 of the supporting member 12 are shown in a deflated condition. The inflated condition of each chamber 20 is shown in phantom view. The pad 30 can house a power supply 31, a pneumatic pump 32 (which is shown in phantom view) and a controller 34 of some sort with a control knob 35. The precise type of pump 32 and controller 34 is not a limitation of the present invention. Further, the size or type of pneumatic tubing (not shown) that is used to connect each of the various chambers 20 to the pump 32 is not a limitation of the present invention. However, the fact that the pump 32 and the controller 34 are portable is a limitation of the present invention.

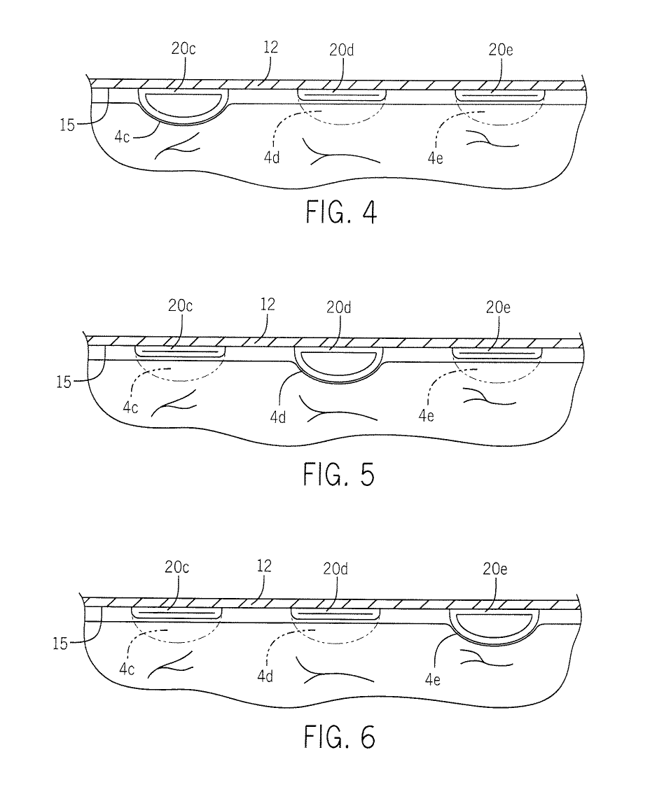

Referring now to FIGS. 4 through 6, they show how the chambers 20c, 20d, 20e are used to propagate a “wave” along a portion of a user's limb 4. As shown, each chamber is disposed along the inner surface 15 of the horizontally-extending portion 14 of the supporting member 12. In this simplified example, the first chamber 20c is inflated, thereby placing pressure on that portion of the user's limb 4c that is immediately adjacent to that first chamber 20c. See FIG. 4 in particular. The second chamber 20d is inflated as the first chamber 20c is deflated, thereby applying pressure on that portion of the limb 4d that is adjacent that chamber 20d. The third chamber 20e functions in the same fashion on that portion of the limb 4e adjacent that chamber 20e. The chambers are intermittently and sequentially-actuated to inflate and deflate in accordance with a pre-programmed scheme. It is to be understood, however, that a given chamber need not be fully deflated before the next adjacent chamber begins to inflate. This will be discussed in more detail later in this detailed description. Again, inflation is accomplished by use of a conventional pneumatic pump 32. The tubing (not shown) that connects the pneumatic pump 32 to the chambers 20 also requires the use of a controller 34 to accomplish the intermittent and sequential compression functionality required or desired. FIG. 3 also demonstrates how opposing chambers 20 can be used to impart a pressure from each side of the supporting member 12. It is to be understood that the type of tubing and the routing of the tubing within the device 10 of the present invention is a design expediency and is not a limitation of the invention. However, the size and type of tubing and how the tubing is routed within the device must be optimized to enhance performance of the device as desired or required with any particular application.

Referring back to FIG. 2, it should be noted that the discrete chambers 20 of the sling 10 are shown as being generally rectangular in shape, each chamber 20 having a margin 21 that is secured to the inner surface 15 of the supporting member 12 of the sling 10. It should be appreciated, however, that the chambers 20 can be arranged such that two adjacent chambers 20 have a common margin between them, as will be discussed in more detail relative to another alternative embodiment presented later in this detailed description.

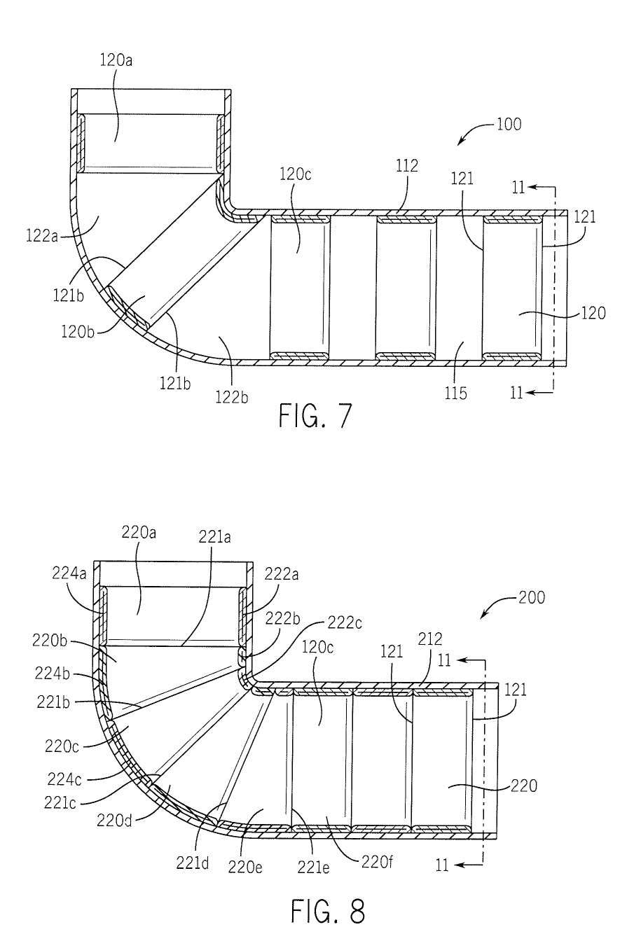

In this last regard, a first alternative embodiment is illustrated in FIG. 7 which shows another sleeve-like sling, which is generally identified 100. In this alternative embodiment, the sling 100 similarly comprises a plurality of inflatable chambers 120. In this configuration, however, and because the sling 100 is sling-like, each chamber is configured to encircle a patient's arm (not shown). When inflated, the chambers 120 impart a pressure on the patient's arm, the chambers 120 fully encircling the patient's arm, as can be appreciated by reviewing FIG. 11. As with the first embodiment, each of the inflatable chambers 120 comprises a pair of sealed margins 121, one to each side of the chamber 120. Significantly, the inflatable chambers 120 of this particular embodiment include at least one uniquely-configured chamber. Specifically, a centrally-placed chamber 120b is configured to encircle the patient's arm, much the same as the other chambers 120 within the configuration would be. This inflatable chamber 120b also comprises sealed margins 121a, 121b, one to either side of the chamber 120b. However, and to prevent the adjacent inflatable chambers 120a, 120c from causing the sling 100 to “straighten out” when those adjacent chambers 120a, 120c are inflated, the inflatable chambers 120a, 120b, 120c are separated by wedge-shaped non-inflating portions 122a, 122b at the surface 115 of the supporting member 112. More specifically, the sealed margins 121a, 121b of the centrally-placed inflatable chamber 120b are immediately adjacent the non-inflating portions 122a, 122b. The use of this particular configuration enables the sling 120 to retain its substantially right-angle orientation during the sequential compression functioning. In short, by widening the outer portions of the non-inflating portions 122a, 122b of this alternative embodiment at or near the patient's elbow, the sling 120 will continue to function as a sling is intended to function while also providing the intermittent and sequential compression functionality desired.

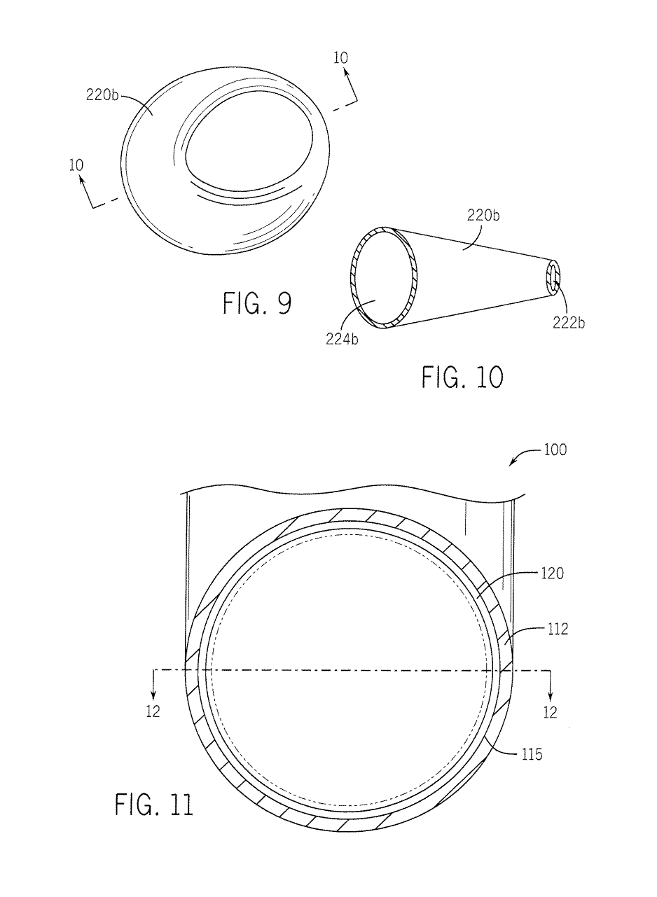

A second alternative embodiment of the device as used once again within a sling is illustrated in FIG. 8, which is generally identified 200. In this alternative embodiment, the sling 200 again comprises a plurality of inflatable and deflatable chambers 220a, 220b, 220c, 220d, 220e, 220f. In this configuration, however, and again because the sling 200 is sling-like, each chamber is configured to encircle a patient's arm (not shown). When inflated, the chambers 220a, 220b, 220c, 220d, 220e, 220f (generically referred to as 220) impart a pressure on the patient's arm, the inflation fully encircling the patient's arm, as can be appreciated by again reviewing FIG. 11. Unlike the first alternative embodiment, each chamber 220 that is disposed immediately adjacent another chamber 220 comprises a common sealed margin 221a, 221b, 221c, 221d, 221e (generically referred to as 221). Significantly, this particular embodiment includes several uniquely-configured chambers 220b, 220c, 220d, 220e. By way of example, the innermost portions 222b, 222c of the chambers 220b, 220c, respectively, have a relatively small amount of expansion space whereas the outermost portions 224b, 224c of the same chambers 220b, 220c have a larger expansion space. In this configuration, and following initialized chamber inflation, the uppermost chamber 220a would inflate and have a generally toroid shape whereas the chamber 220b next below it would have the shape of a cyclide or, more particularly, the shape of a “Dupin” cyclide. See FIGS. 9 and 10. The existence of the sealed margin 221a between those two chambers of the inflated chambers 220b, 220c allows for inflation of one chamber while the chamber that is immediately “upstream” from it will begin to deflate and so on, thereby propagating a pressure “wave” along the patient's limb and stimulating blood flow via those chambers 220.

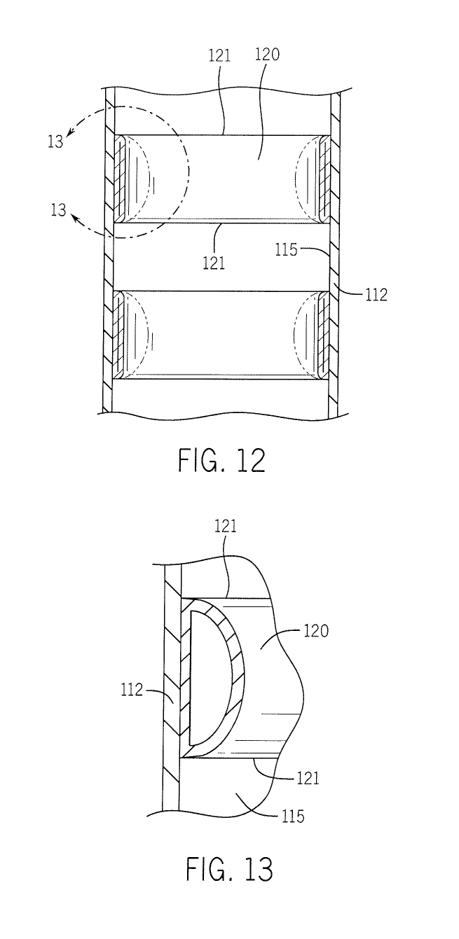

FIGS. 12 and 13 illustrate cross-sections of the encircling chambers 120 used in the first alternative embodiment, such chambers 120 being generally tubular in design. With this type of inflatable chamber 120, there is no top or bottom margin as the chamber 120 forms a continuous tube loop. Only side margins 121 need be provided in this particular embodiment.

Referring back to the concept of both the first and the second alternative embodiments, both embodiments 100, 200 would allow inflation of all chambers 120, 220 intermittently and sequentially, without the tendency of the devices 100, 200 to straighten out. Instead, the devices 100, 200 would tend to allow the bend in the devices 100, 200 to be maintained during the inflation-deflation cycle. It is also to be understood that the devices 100, 200 of both embodiments could be used where the devices 100, 200 are open at an upper portion, much like the originally-disclosed embodiment of the same device 10, and still maintain this functionality. That is, the chambers 120, 220 could be formed in a substantially U-shaped cross-section with the chambers 120, 220 being broader at the bottom and narrower at the top. Again, the precise size of the chambers 120, 220 would be a design expediency.

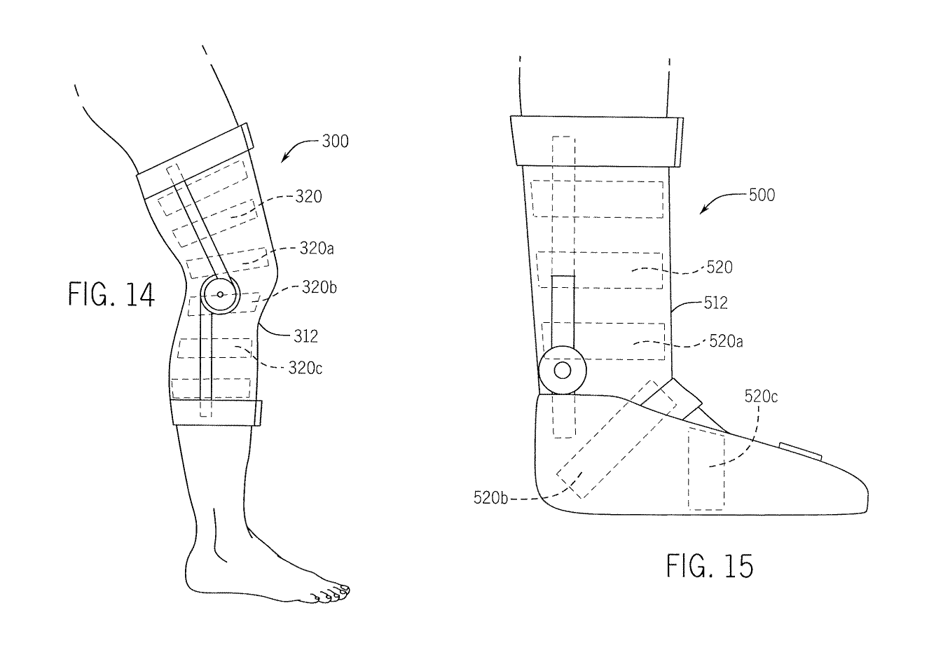

As illustrated in FIG. 14, another alternative embodiment of the present invention is shown. This embodiment shows use of the present invention within a knee brace, which is generally identified 300. As shown, the knee brace 300 comprises a plurality of chambers 320 (shown in phantom view) which can be configured as encircling or non-encircling chambers as described above within a supporting structure 312. The chambers 320a, 320b, 320c that are disposed at the knee joint of the patient would function as described above and would be accompanied by the same pneumatic pumping structure and functionality that is described above as well. Further, this embodiment could comprise a plurality of chambers 320 such that the chambers are separately disposed away from other chambers or, alternatively, such that the chambers 320 comprise a margin that is common with the next adjacent chamber 320. In the case of the knee brace 300, either embodiment would allow flexion and extension of the patient's knee.

FIG. 15 illustrates yet another alternative embodiment of a device constructed in accordance with the present invention, the embodiment comprising a foot and ankle boot. The boot is generally identified 500. As shown, the boot 500 comprises a plurality of chambers 520 (also shown in phantom view) which can be configured as encircling or non-encircling chambers within a supporting structure 512 as well. The chambers 520a, 520b, 520c that are disposed at the ankle joint of the patient would function as described above and would be accompanied by the same pneumatic pumping structure and functionality that is described above as well, although the ankle may be in more of a fixed position, such as was described above relative to the sling 10. This embodiment could comprise a plurality of chambers 520 such that the chambers are separately disposed away from other chambers or, alternatively, such that the chambers 520 comprise a margin that is common with the next adjacent chamber 520. In the case of the ankle brace 500, either embodiment would allow full exposure of the chambers 520 to all portions of the patient's ankle, since the ankle is a joint with the highest risk for blood clots after fractures or surgery.

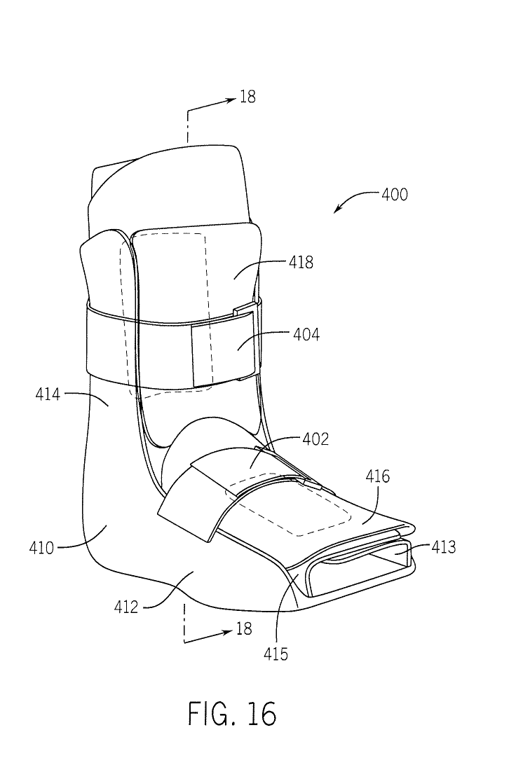

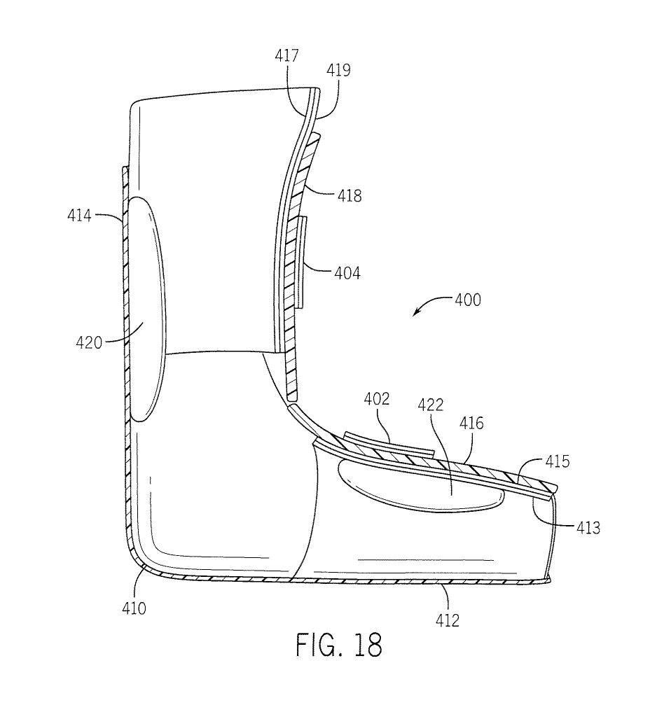

FIGS. 16-20 illustrate yet another alternative embodiment of a device in accordance with the present invention, the embodiment comprising a walking boot or brace. The boot as illustrated is fairly generic of different walking boots and braces that are known in the industry and is generally identified 400. Typically, the boot 400 comprises a supportive outer shell 410 having a bottom shell portion 412 and a rear shell portion 414. The bottom shell portion 412 is disposed below the patient's foot (not shown) and the rear shell portion 414 is disposed behind the posterior leg muscles (also not shown). The boot 400 further comprises a top shell portion 416 and a front shell portion 418. The top shell portion 416 is disposed atop the foot dorsum and the front shell portion 418 is disposed atop the lower portion of the patient's shin. As also shown in FIG. 16, the boot 400 comprises a plurality of overlapping foot pads 413, 415 which are disposed below the top shell portion 416 of the boot. Similar pads 417, 419 are disposed behind the front shell portion 418. See also FIG. 18. Complementary straps 402, 404 are provided to keep the boot shell portions and pads intact and in place during use by the patient. The straps are typically provided as hook and loop fasteners, such as VELCRO® fasteners (VELCRO is a registered mark of Velcro Industries B.V.).

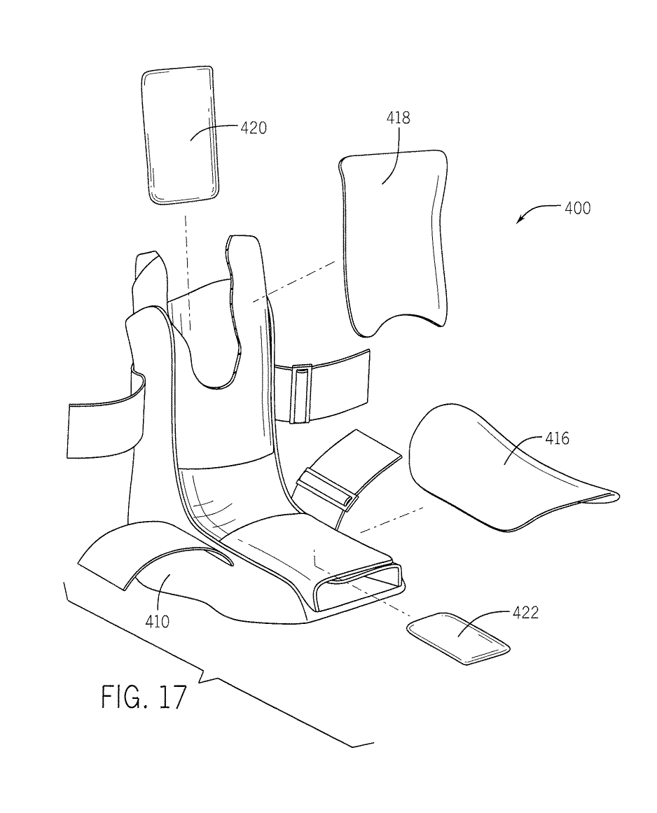

Looking now to FIG. 17, it shows an exploded view of the boot 400 and its component elements including, most notably, chambers 420, 422 which are configured as non-encircling chambers. These chambers 420, 422 would function as described above and would be accompanied by the same type of pneumatic pumping and tubing structure and pumping functionality that is described above—that is, such as was described above relative to the ankle brace 500. See again FIG. 15.

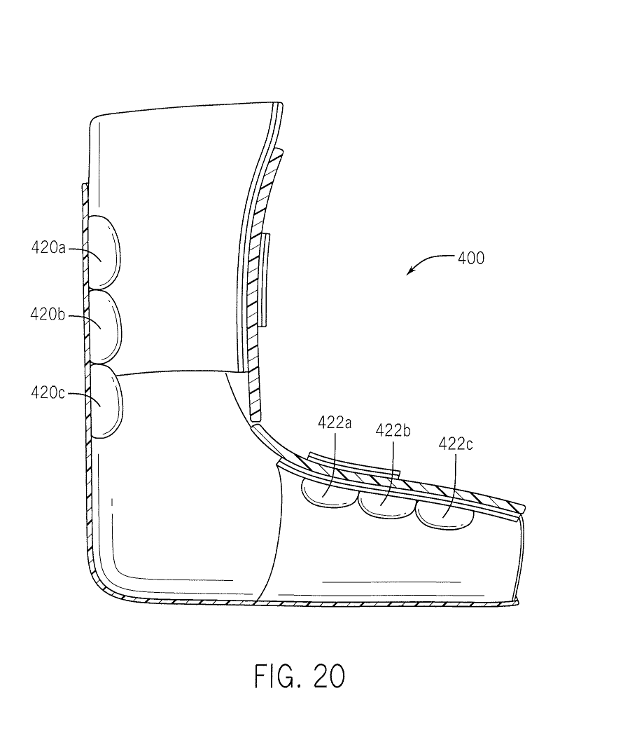

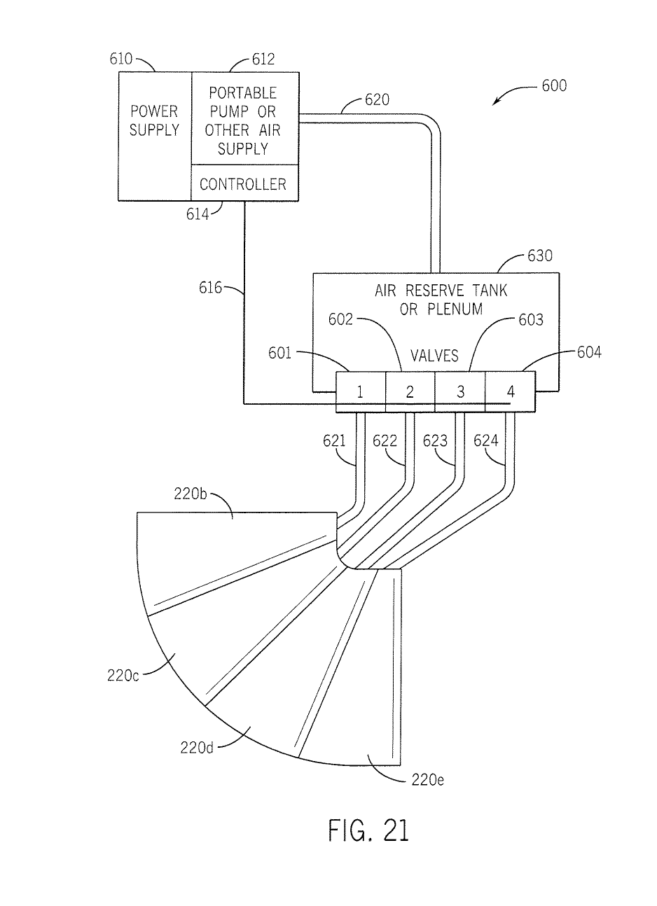

It is to be understood, however, that this embodiment could also comprise a plurality of chambers 420a, 420b, 420c at that part of the boot 400 which is opposite the front shell portion 418 and another plurality of chambers 422a, 422b, 422c at that part of the boot 400 which comprises the top shell portion 416. See FIG. 20. In this way, intermittent and sequential compression functionality can be applied in the area of the foot and ankle, the ankle being a joint with the highest risk for blood clots after fractures or surgery. The sequencing would be similar to that illustrated in FIGS. 4-6 although the chamber margins are adjacent one another in this alternative embodiment.

In the case of the walking boot 400 referenced above, it is also within the scope of the present invention that such a boot 400 of current manufacture has any known type of substantially vertical or upright anterior/posterior structure and substantially horizontal medial/lateral structure, be it “shells” or other functional equivalents, all for limb constraint, stabilization and support, into which the sequential compression concept can be incorporated. It is also within the scope of the present invention to place the sequential compression chambers elsewhere within the same boot 400 to further enhance blood flow within the patient's lower extremity. The present invention is not limited to the precise chamber placements disclosed herein, or to the number of such chambers, both of which have been made strictly for purposes of illustrating enablement of the present invention. The present invention is not limited in this particular regard. Relative to the walking boot 400, the present invention is also not limited in any way to how far the chambers wrap around the lower leg or foot, such being a design expediency. That is, the chambers could be configured as encircling or non-encircling chambers while maintaining the desired functionality.

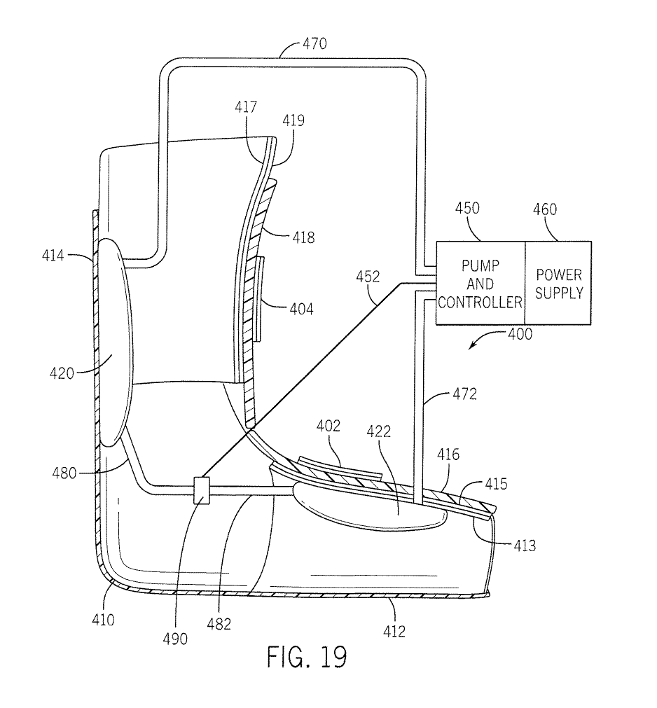

Referring specifically to FIG. 19, it shows the walking boot 400 together with pumping and valving schematics. The notion behind this particular embodiment is that it may be desirable, for example, to not immediately initiate any sort of tissue compression due to surgical wound sites that could be disposed under or next to a compression element 420, 422. As shown, the boot 400 further comprises a power supply 460, which is intended to be transported with or as part of the boot 400. The power supply 460 allows the actuation of a pneumatic pump and controller 450. Tubing 470, 472 carries pressurized air to the rearward inflatable chamber 420 and to the chamber 422 disposed atop the foot, respectively. For the reasons stated above, it is also desirable to include a valve 490 which has tubing 480, 482 running between it and the respective inflatable chambers as shown. The valve 490 is likewise controlled by the controller 450 which could prevent air flow between chambers. When the valve 490 is open, air pressurization may alternate between the chambers 420, 422 in somewhat of a sequential compression mode, albeit only two chambers are used. When the valve 490 is closed, such mode would be prevented. It is to be understood that this functionality can be accomplished with the other configurations relating to the elbow and knee joints as previously discussed.

Referring to FIGS. 21-23, they are schematic representations that illustrate the “interconnectedness” of the power supply, the pump, the chamber tubing and the chambers, all of which is required to accomplish the intended functionality in a number of exemplary systems.

Starting with FIG. 21, it illustrates a system, generally identified 600, that uses a preferably portable power supply 610 to energize a portable “on-board” pneumatic pump 612 and an electronic controller 614. Compressed air is carried from the pump 612 to an air reserve tank or plenum 630 via air tubing 620. In this embodiment, a plenum 630 is used as plenums are known “holding tanks” for compressed air which, when used, result in the pump 612 having to pump air only when the air pressure within the plenum 630 drops below a certain level. This can result in a lower power draw on the power supply 610. Absent such plenum 630, the pneumatic pump essentially pumps “on demand” as air is required to fill the inflatable chambers in accordance with the present invention. In this exemplar embodiment, four valves 601, 602, 603, 604 are controlled via a signal wire 616 by the controller 614. It is to be understood here that four valves are shown only for purposes of showing enablement and the present invention is not so limited.

Each air valve 601, 602, 603, 604 carries compressed air to an inflatable chamber 220b, 220c, 220d, 220e (as per the embodiment shown in FIG. 8) via an inlet port 621, 622, 623, 624, respectively. It is to be understood that each chamber 220 also comprises a bleeder valve (not shown) to release pressurized air from the chamber 220 into the atmosphere, the pressurized air exceeding the atmospheric pressure.

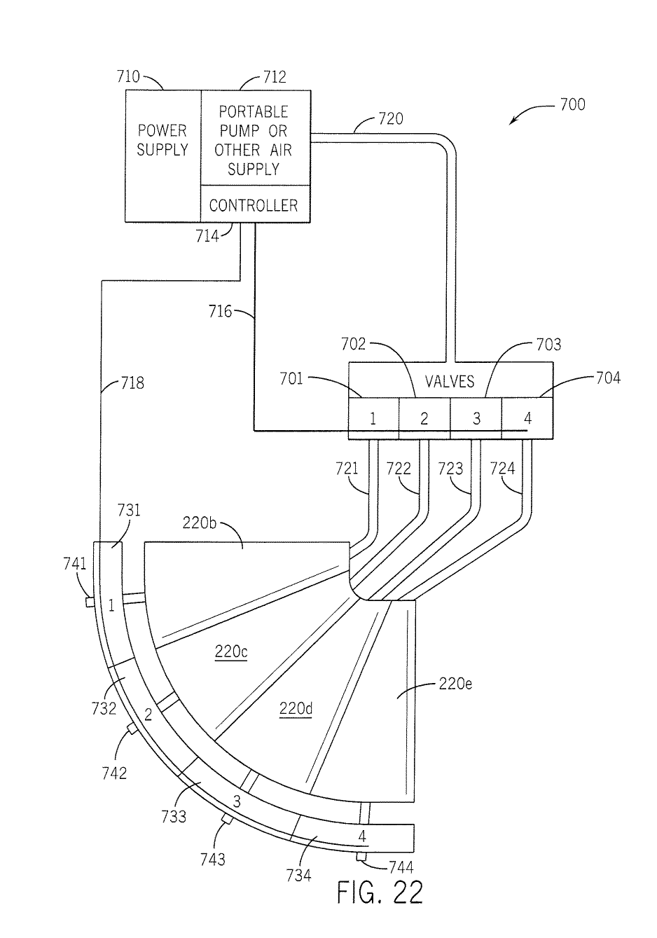

Referring now to FIG. 22, it illustrates a first alternative system, generally identified 700, that likewise uses a preferably portable power supply 710 to energize a portable “on-board” pneumatic pump 712 and an electronic controller 714. Compressed air is carried from the pump 712 to four valves 701, 702, 703, 704, which are controlled via a signal wire 716 from the controller 714. Again, it is to be understood that four valves are shown only for purposes of showing enablement. Each air valve 701, 702, 703, 704 carries compressed air to the inflatable chambers 220b, 220c, 220d, 220e (as per the embodiment shown in FIG. 8) via an inlet port 721, 722, 723, 724, respectively. The controller 714 is also used to actuate outlet valves 731, 732, 733, 734 to bleed compressed air into the atmosphere via outlet ports 741, 742, 743, 744, respectively, via a signal wire 718. In an exemplary sequence, air flow would be applied intermittently (i.e. for a preprogrammed period of time) and sequentially (the sequence continuing for another preprogrammed period of time) to the chambers and would look something like this:
valve 701 opens and fills chamber 220b quickly;
valve 702 opens and fills chamber 220c quickly;
valve 741 opens and vents chamber 220b slowly;
valve 703 opens and fills chamber 220d quickly;
valve 742 opens and vents chamber 220c slowly;
valve 704 opens and fills chamber 220e quickly;
valve 743 opens and vents chamber 220d slowly;
and so on until the sequence times out.

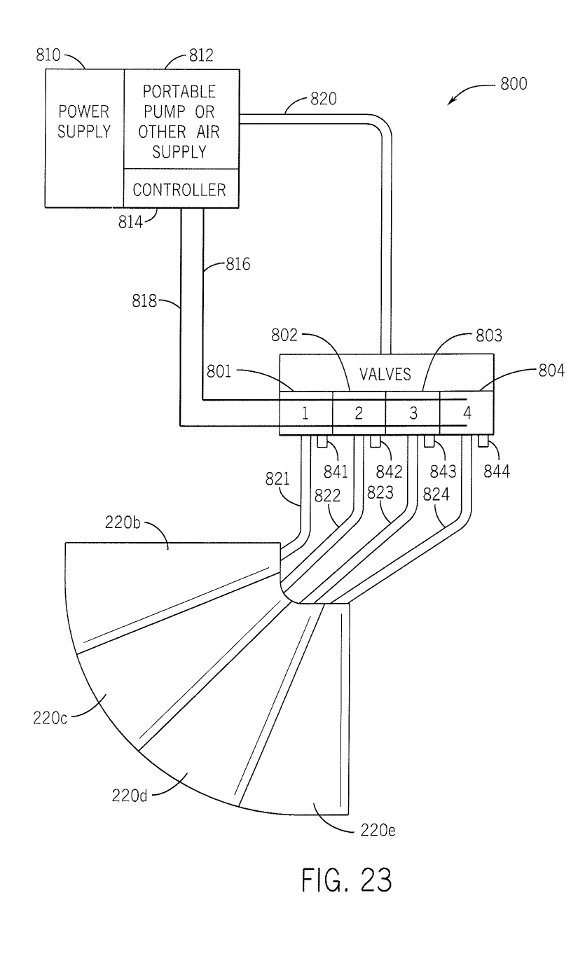

Referring now to FIG. 23, it illustrates a second alternative system, generally identified 800, that also uses a preferably portable power supply 810 to energize a portable “on-board” pneumatic pump 812 and an electronic controller 814. Compressed air is carried from the pump 812 to four valves 801, 802, 803, 804, which are controlled to “open” to the chamber inlet port 821, 822, 823, 824 via a signal wire 816 from the controller 814. Each valve 801, 802, 803, 804 in this embodiment is also controlled via a second signal wire 818 to allow a vent port 841, 842, 843, 844 to bleed pressurized air into the atmosphere. That is, compressed air is forced into the inflatable chambers 220b, 220c, 220d, 220e (as per the embodiment shown in FIG. 8) via an inlet port 821, 822, 823, 824, respectively. The controller 814 is also used to actuate the vent ports 841, 842, 843, 844 to bleed compressed air into the atmosphere via the signal wire 818. In a very similar exemplary sequence, air flow would be applied intermittently (i.e. for a preprogrammed period of time) and sequentially (the sequence continuing for another preprogrammed period of time) to the chambers and would look something like this:
valve 801 opens and fills chamber 220b quickly;
valve 802 opens and fills chamber 220c quickly;
valve 841 opens and vents chamber 220b slowly;
valve 803 opens and fills chamber 220d quickly;
valve 842 opens and vents chamber 220c slowly;
valve 804 opens and fills chamber 220e quickly;
valve 843 opens and vents chamber 220d slowly;
and so on for the duration of the preprogrammed sequencing time.

When the preprogrammed sequencing time expires, the pneumatic pump 812 is de-energized for a preprogrammed amount of time which is set to intermittently activate and deactivate the system 800. Again, it is to be understood that the compressive chambers are intermittently and sequentially-actuated to inflate and deflate in accordance with a pre-programmed scheme and that a given chamber need not be fully deflated before the next adjacent chamber begins to inflate.

Inflation is best accomplished by use of a conventional pneumatic pump. However, it would also be possible to utilize a container (such as a small tank) of pressurized air—much like the plenum 630 in the system 600—to actuate any of the systems 600, 700, 800, which would eliminate the need for a pneumatic pump 612, 712, 812 in those systems, respectively. However, the systems 600, 700, 800 would still require a power supply 610, 710, 810 to actuate the controllers 614, 714, 814, respectively. It is also to be understood that the type of tubing and the routing of the tubing within any of the configurations disclosed herein is a design expediency and not a limitation of the present invention.

Based on the foregoing, it will be seen that there has been provided a new and useful device and method wherein inflatable chambers are disposed within the intermittent and sequential compression device at or near a joint, such as at an elbow or a knee, can be positioned in a certain way to allow inflation of the chamber without the overall structure being pushed into a longitudinal position. Alternatively, chambers can be configured to be contoured such that inflation will accomplish the inflation/deflation functionality while also maintaining the overall angularity of the device relative to the user's limb joint. In all embodiments, potential modalities are envisioned to achieve intermittent and sequential compression in a medical device to prevent blood clots, relieve edema, and possible treatment of lymphedema.

The details of the invention having been disclosed in accordance with the foregoing, I claim:

1. A portable intermittent and sequential compression device for application to the bent or bendable joint of a patient's limb comprising:
a limb joint support;
a plurality of discrete air chambers incorporated into the limb joint support, each air chamber being configured and positioned such that the plurality of air chambers negotiate the bent joint of the patient's limb while the limb joint is disposed within the limb joint support;
each air chamber of the plurality of air chambers further having a port for inflating the chamber and a port for deflating the chamber;
an air compression pump;
tubing that connects each discrete air chamber to the air compression pump; and
a controller for actuating the air compression pump to inflate and deflate the air chambers via the ports in accordance with a pre-programmed scheme, the pre-programmed scheme providing the air chambers with intermittent and sequential compression that simulates blood circulation around the bent or bendable joint of the patient's limb.

2. The portable compression device according to claim 1, wherein each air chamber comprises a sealed peripheral margin.

3. The portable compression device according to claim 2, wherein the sealed peripheral margins of adjacent chambers are common.

4. The portable compression device according to claim 1, wherein air chambers are located above, below and on the limb joint.

5. The portable compression device according to claim 1, wherein each air chamber is configured to fully encircle the limb joint.

6. The portable compression device according to claim 5, wherein at least one air chamber disposed about the limb joint is configured in the shape of a Dupin cyclide.

7. The portable compression device according to claim 1, wherein each air chamber is configured to partially encircle the limb joint.

8. The portable sequential compression device according to claim 1 further comprising a portable power supply for the air compression pump and the controller.

9. The portable sequential compression device according to claim 8, wherein said portable power supply comprises a rechargeable battery.

10. The portable sequential compression device according to claim 1, wherein the limb joint support is one from a group consisting of an arm sling, a knee brace and an ankle brace.

11. A method for providing intermittent and sequential compression to the bent or bendable joint of a patient's limb comprising the steps of:
providing a limb joint support;
providing a plurality of discrete air chambers incorporated into the limb joint support;
providing each air chamber with a port for inflating the chamber and a port for deflating the chamber;
providing an air compression pump;
providing tubing that connects each chamber to the air compression pump;
providing a controller for actuating the air compression pump to inflate and deflate the chambers via the ports in accordance with a pre-programmed scheme; and
actuating the air compression pump in accordance with the pre-programmed scheme to provide intermittent and sequential compression via the chambers to simulate blood circulation around the bent or bendable joint of the patient's limb.

12. The intermittent and sequential compression method according to claim 11 further comprising the step of providing each air chamber with a sealed peripheral margin.

13. The intermittent and sequential compression method according to claim 12 further comprising the step of providing the sealed peripheral margins of adjacent air chambers with common margins.

14. The intermittent and sequential compression method according to claim 11 further comprising the steps of locating at least one air chamber above the limb joint, at least one air chamber below the limb joint and at least one air chamber on the limb joint.

15. The intermittent and sequential compression method according to claim 11 further comprising the step of configuring each air chamber to fully encircle the limb joint.

16. The intermittent and sequential compression method according to claim 15 wherein at least one air chamber that encircles the limb joint is configured in the shape of a Dupin cyclide.

17. The intermittent and sequential compression method according to claim 11 further comprising the step of configuring each air chamber to partially encircle the limb joint.

18. The intermittent and sequential compression method according to claim 11 further comprising the step of providing a portable power supply for the air compression pump and the controller.

19. The intermittent and sequential compression method according to claim 18 wherein the portable power supply comprises a rechargeable battery.

20. The intermittent and sequential compression method according to claim 11 wherein the limb joint support is one from a group consisting of an arm sling, a knee brace and an ankle brace.
